(19) United States
(12) Patent Application Publication
(10) Pub. No.: US 2024/0200871 A1
(43) Pub. Date: Jun. 20, 2024

(54) FREEZE-DRYING TRAY ASSEMBLY

(71) Applicant: Teleflex Life Sciences LLC, Wilmington, DE (US)

(72) Inventors: James A. Murto, Maple Grove, MN (US); Stephen A. Penegor, Watertown, MN (US)

(73) Assignee: Teleflex Life Sciences LLC, Wilmington, DE (US)

(21) Appl. No.: 18/390,149

(22) Filed: Dec. 20, 2023

Related U.S. Application Data
(60) Provisional application No. 63/476,258, filed on Dec. 20, 2022.

(51) Int. Cl. F26B 5/06; F26B 25/18

(52) U.S. Cl. CPC F26B 5/065; F26B 25/18

(57) ABSTRACT

Assemblies, systems, and methods for preventing contamination and alteration of a biological material during and after freeze-drying processes are disclosed. Tray assemblies configured to hold the biological material in a container during a freeze-drying process include a tray and complementary lid. The lid can include compressible leg members configured to transition from an extended configuration to a compressed configuration in response to a downward force applied against the lid when the lid is positioned above the tray. A gap exists between an upper edge of the tray and an underside of the lid when the leg members are extended. With the legs extended and the tray assembly open, the tray assembly is freeze-dried. After freeze-drying is complete, the legs can be compressed and the lid sealed against the tray, enclosing the biological material within the assembly, and protecting it from contamination and ambient air exposure within and outside the chamber.

### CROSS-REFERENCE TO RELATED APPLICATIONS

This application claims the benefit of priority under 35 U.S.C. § 119(c) to U.S. Provisional Appln. Ser. No. 63/476,258, filed Dec. 20, 2022, which is incorporated herein by reference in its entirety.

### TECHNICAL FIELD

This patent document pertains to an assembly, system, and method for, among other things, freeze-drying and packaging a material under aseptic or pathogen-reduced conditions.

### BACKGROUND

Dry storage can increase the shelf life and convenience of biological material and its use. Freeze-drying (or lyophilization) is a process for drying heat-sensitive substances, such as biological materials, by freezing the substances and then subliming the ice or other frozen solvent in a high vacuum.

It can be necessary to keep biological material free from micro-organisms and other contaminants to avoid decomposition of the material and to prevent possible infections when the material is used. Biological material can be exposed to contaminants and undesired atmospheric conditions during transportation to and from a freeze-dryer used for freeze-drying. As a result, the operating area in which freeze-drying is carried out undergoes frequent sterilization to minimize exposure of the biological material to contaminants and ambient air. This adds to the labor and costs associated with freeze-drying.

Many freeze-drying processes involve placing open containers of biological material in the freeze-dryer. The containers remain open to the environment until the freeze-drying process is complete to allow a path for solvent vapor to be removed from the biological material. This practice exposes the biological material to potential contamination during the freeze-drying process, especially when the freeze-dryer is opened after the freeze-drying process is complete. To minimize the opportunity for contamination and unwanted air exposure during and after the freeze-drying process, the freeze-drying equipment can be sterilized using steam or chemicals before loading each new batch of biological material to be processed. This also adds to the labor and costs associated with freeze-drying.

Moreover, using existing assemblies, systems, and methods, certain freeze-dried biological material may need to be repackaged after being dried. This repackaging presents yet another opportunity to introduce contaminants into the biological material and further adds to the labor and costs associated with freeze drying.

### OVERVIEW

The present inventors recognize, among other things, that a need exists for new assemblies, systems, and methods that address the concerns of material contamination and air exposure during and after the freeze-drying process, including by freeze-drying equipment, the area surrounding the freeze-drying equipment, and the repackaging of freeze-dried product. The inventors recognize that biological material, such as blood plasma, is associated with a risk of contamination each time it is exposed to the environment. The inventors also recognize that the assembly, system, and method should be economical and practical on a production scale.

The present disclosure provides assemblies, systems, and methods for protecting biological material from contamination and exposure to uncontrolled atmospheric conditions through the steps of filling, freeze-drying, packaging, storing and use. A system can include a freeze-drying tray assembly configured to receive one or more containers each containing a biological material, such as blood plasma. The containers can comprise flexible containers similar or identical to those shown and described in U.S. Pat. No. 9,561,893, the entire contents of which are incorporated by reference herein.

A method can involve inserting a biological material into a container prior to freeze-drying and placing the container in a freeze-drying tray. The freeze-drying tray can be coupled with a complementary lid featuring one or more compressible members, such as leg members each in an extended configuration, such that upon coupling the lid with the tray, a gap exists between the two components. While the gap remains, the biological material can be freeze-dried in the tray assembly. After freeze-drying, the biological material can be sealed within the tray assembly by compressing the compressible members, referred to herein generally as “leg members,” and forcing the lid against the tray. The freeze-drying chamber can be opened and the closed tray assembly removed therefrom with the container enclosed within the assembly, where freeze-drying conditions may be maintained and the container shielded from contamination and exposure to uncontrolled atmospheric conditions that may compromise the state and integrity of the freeze-dried material.

To further illustrate the assemblies, systems, and methods disclosed herein, a non-limiting list of examples is provided here:

In Example 1, a freeze-drying tray assembly can include a tray configured to receive one or more containers each containing a liquid. The assembly can also include a lid complementary to the tray and including one or more compressible members configured to transition from an extended configuration to a compressed configuration in response to a downward force applied against the lid when the lid is positioned above the tray. A gap can exist between an upper edge of the tray and an underside of the lid when the one or more compressible members are in the extended configuration. The lid can be sealed against the upper edge of the tray when the one or more compressible members are in the compressed configuration.

In Example 2, the assembly of Example 1 can optionally be configured such that the assembly also includes a gasket attached to the upper edge of the tray.

In Example 3, the assembly of any one of Examples 1 or 2 can optionally be configured such that the tray includes one or more dividers configured to define two or more cavities within the tray, each of the cavities configured to receive at least one of the containers.

In Example 4, the assembly of Example 3 can optionally be configured such that the dividers are movable within the tray

In Example 5, the assembly of any one or any combination of Examples 1-4 can optionally be configured such that each of the compressible members comprises a compressible leg member having a first portion and a second portion, the first portion movable relative to the second portion.

In Example 6, the assembly of Example 5 can optionally be configured such that the first portion comprises a telescoping detent pin member.

In Example 7, the assembly of Example 6 can optionally be configured such that the second portion comprises a tube member configured to receive the telescoping detent pin member.

In Example 8, the assembly of Example 7 can optionally be configured such that the tube member is attached to the underside of the lid and the telescoping detent pin member is configured to extend to an interior floor surface of the tray.

In Example 9, the assembly of Example 8 can optionally be configured such that a support base of the telescoping detent pin member is configured to contact the interior floor surface of the tray.

In Example 10, the assembly of any one or any combination of Examples 1-9 can optionally be configured such that the tray and the lid comprise stainless steel.

In Example 11, the assembly of any one or any combination of Examples 1-10 can optionally be configured such that the assembly also includes a vent port attached to the tray.

In Example 12, the assembly of any one or any combination of Examples 1-11 can optionally be configured such that the tray has a length of about 20 inches to about 40 inches.

In Example 13, the assembly of any one or any combination of Examples 1-12 can optionally be configured such that the tray has a width of about 8 inches to about 20 inches.

In Example 14, the assembly of any one or any combination of Examples 1-13 can optionally be configured such that the tray has a height of about 1 inch to about 5 inches.

In Example 15, a system for freeze-drying biological material can include at least one gas-impermeable container configured to receive a biological material and a tray assembly configured to contain the at least one gas-impermeable container. The tray assembly can include a tray configured to receive the at least one gas-impermeable container. The tray assembly can also include a lid complementary to the tray and including one or more compressible members configured to transition from an extended configuration to a compressed configuration in response to a downward force applied against the lid when the lid is positioned above the tray. A gap can exist between an upper edge of the tray and an underside of the lid when the one or more compressible members are in the extended configuration. The lid can be sealed against the upper edge of the tray when the one or more compressible members are in the compressed configuration.

In Example 16, the system of Example 15 can optionally be configured to also include a movable freeze-dryer shelf.

In Example 17, the system of Example 16 can optionally be configured such the movable freeze-dryer shelf is configured to apply the downward force against the lid sufficient to seal the lid against the upper edge of the tray.

In Example 18, the system of any one or any combination of Examples 15-17 can optionally be configured such that the tray assembly also includes a vent port.

In Example 19, the system of any one or any combination of Examples 15-18 can optionally be configured such that the biological material includes blood plasma.

In Example 20, the system of any one or any combination of Examples 15-19 can optionally be configured such that each of the one or more compressible members comprises a compressible leg member.

In Example 21, a method for freeze-drying and handling a biological material can involve placing a gas-impermeable container filled with a biological material into a cavity defined by a tray of a tray assembly. The method can also involve positioning a lid complementary to the tray over the tray, such that compressible members protruding from an underside of the lid extend into the cavity and a gap exists between an upper edge of the tray and the underside of the lid. The method can also involve freeze-drying the tray assembly in a freeze-drying chamber, compressing the compressible members by applying a downward force against the lid until the gap between the upper edge of the tray and the underside of the lid is closed, and removing the tray assembly from the freeze-drying chamber.

In Example 22, the method of Example 21 can optionally be configured such that applying a downward force against the lid involves lowering a freeze-dryer shelf positioned above the lid against the lid.

In Example 23, the method of any one of Examples 21 or 22 can optionally be configured such that the biological material includes blood plasma.

In Example 24, the method of any one or any combination of Examples 21-23 can optionally be configured such that the compressible members comprise compressible leg members.

These and other examples and objects of the present assemblies, systems, and methods will be set forth in the following Detailed Description. This Overview is intended to provide non-limiting examples of the present subject matter—it is not intended to provide an exclusive or exhaustive explanation. The Detailed Description below is included to provide further information about the present assemblies, systems, and methods.

### BRIEF DESCRIPTION OF THE DRAWINGS

In the drawings, like numerals can be used to describe similar features and components throughout the several views. The drawings illustrate generally, by way of example but not by way of limitation, various embodiments discussed in the present patent document.

FIG. 1A illustrates an exploded view of a freeze-drying tray assembly as constructed in accordance with at least one embodiment.

FIG. 1B illustrates a plan view of the freeze-drying tray assembly shown in FIG. 1A.

FIG. 1C illustrates a side view of the freeze-drying tray assembly shown in FIG. 1A in an open configuration.

FIG. 1D illustrates a side view of the freeze-drying tray assembly in the open configuration shown in FIG. 1C with a freeze-drying shelf positioned above the assembly.

FIG. 1E illustrates an underside of the lid of the freeze-drying tray assembly shown in FIG. 1A.

FIG. 2A illustrates a tray of a freeze-drying tray assembly including multiple dividers as constructed in accordance with at least one embodiment.

FIG. 2B illustrates the tray shown in FIG. 2A without the dividers.

FIG. 2C illustrates one of the dividers shown in FIG. 2A.

FIG. 2D illustrates the lid of the freeze-drying tray assembly shown in FIG. 2A.

FIG. 2E illustrates a leg member component of the freeze-drying tray assembly shown in FIG. 2A.

FIG. 3 illustrates a tray of a freeze-drying tray assembly as constructed in accordance with at least one embodiment.

FIG. 4A illustrates a freeze-drying tray assembly that includes a vent port as constructed in accordance with at least one embodiment.

FIG. 4B illustrates a close-up view of the vent port shown in FIG. 4A.

FIG. 5 illustrates a method of freeze-drying and preventing contamination of a biological material in accordance with at least one embodiment.

The drawing figures are not necessarily to scale. Certain features and components may be shown exaggerated in scale or in schematic form and some details may not be shown in the interest of clarity and conciseness.

### DETAILED DESCRIPTION

The present subject matter includes a freeze-drying tray assembly and associated systems and method of use to protect material from contamination and exposure to uncontrolled atmospheric conditions through the steps of filling, freeze-drying, packaging, and storing. The material may comprise a biological material, such as blood plasma, which may be susceptible to harmful contamination. Examples of the method may involve inserting the biological material into a container and placing the container in a tray assembly. The tray assembly may include a tray defining one or more cavities configured to receive the container, along with a complementary lid configured to couple with the tray in an adjustable manner that allows the tray assembly to be switched between an open configuration and a closed configuration. In the open configuration, uncompressed members, such as uncompressed leg members, that extend within the tray from the underside of the lid may create a gap between the top edge of the tray and the underside of the lid. The tray assembly may be placed in a freeze-drying chamber and the freeze drying process initiated with the tray assembly in the open configuration, such that air and solvent vapor can exit the container through the gap during the process. After freeze-drying, the tray assembly can be switched to the closed configuration by compressing the leg members upon urging the lid toward the top edge of the tray with the container(s) enclosed and optionally locked therein. Sealed within the tray assembly, the container filled with freeze-dried material may be moved or otherwise handled within or outside the freeze-drying chamber without being exposed to air and associated contamination risks. In addition to minimizing the risk of contamination, the sealed tray assembly may maintain a controlled atmosphere therein, such as an atmosphere having a specific gas content (e.g., nitrogen content), temperature, and/or humidity level established during the freeze-drying process and not otherwise present in the ambient atmosphere surrounding the freeze-drying chamber. Maintaining desired atmospheric conditions within the tray assembly may prevent air-induced degradation and/or alteration of the freeze-dried material, thereby preserving its integrity and prolonging its shelf life.

The method can be performed using the assemblies and systems shown in the drawings and described herein. The system provides a practical, reusable freeze-drying tray assembly configured to house one or more containers during a freeze-drying process and enclose the containers after freeze-drying, thereby minimizing exposure of the containers to contaminants and maintaining controlled atmospheric conditions within the assembly after freeze-drying is complete.

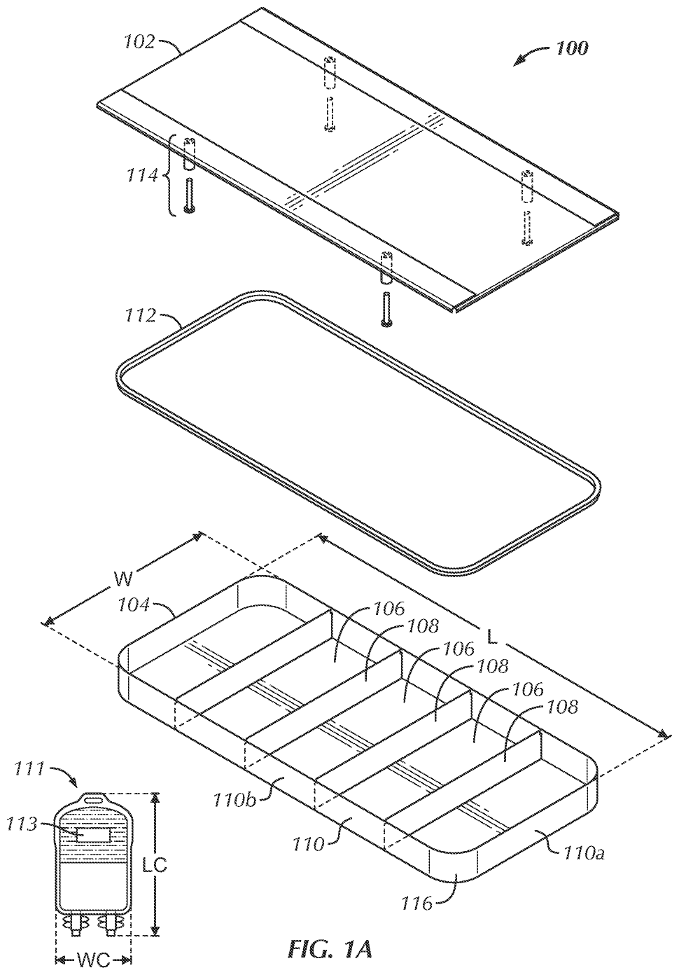

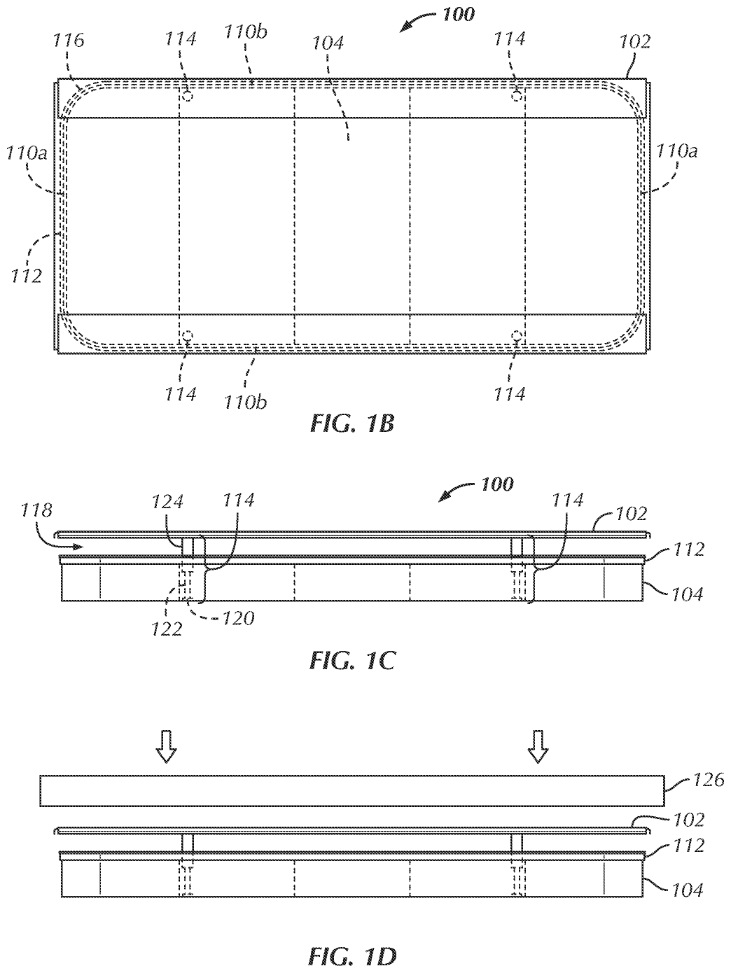

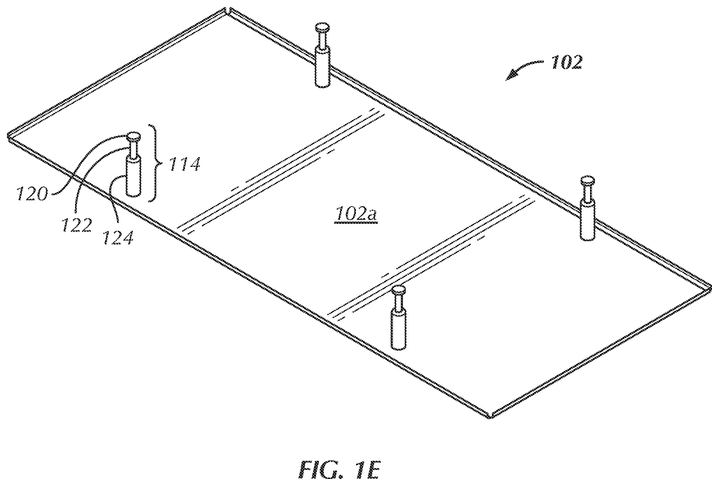

FIG. 1A illustrates an exploded view of a tray assembly 100 configured to receive and enclose multiple containers each configured to contain a material, such as blood plasma from one or more donors. For ease of illustration, “material” will be used interchangeably with “biological material” herein.

The tray assembly 100 includes a lid 102 and a complementary tray 104 that includes one or more cavities 106 defined by partitions or dividers 108 positioned within the perimeter wall 110 of the tray 104, each cavity 106 configured to receive at least one container 111. The perimeter wall 110 may include two end portions 110a and two side portions 110b defining the width W and length L of the tray 104, respectively. Other suitable geometric shapes are within the scope of this disclosure. A sealing member 112, such as a gasket, O-ring or washer, can be secured to a top portion of the perimeter wall 110, where it may be sandwiched between the tray 104 and the lid 102 upon pressing the lid against the tray, for example after freeze-drying, to aid in sealing the container(s) 111 within the closed assembly. One or more adjustable leg members 114 may be secured or attached to the lid 102, such that upon coupling the lid 102 with the tray 104, each of the leg members 114 protrudes within one of the cavities 106 defined by the tray 104. Alternatively, the leg members 114 may be attached to the tray 104, or to both the lid 102 and the tray 104, or to neither. The length of each leg member 114 in an uncompressed configuration may be greater than the depth of the tray 104, such that a vertical gap remains between the lid 102 and the tray 104 after coupling, but before sealing, the lid 102 with the tray 104. The compressible leg members 114 of the present disclosure include any suitably shaped or configured adjustable structure. The leg members 114 may be adjustable, e.g., collapsible, compressible, or telescopic, such that upon pressing the lid 102 against the tray 104, the length of the leg members 114 may decrease to eliminate the gap between the two components. In some embodiments, the leg members 114 may be integral or secured to the underside of the lid 102, such that the leg members 114 may be considered part of the lid 102.

The tray 104 depicted in FIG. 1A includes dividers 108, in this example four dividers defining five cavities 106, each cavity 106 sized and configured to receive at least one container 111. Embodiments are not limited to five cavities 106, as the number of cavities 106 may range from one to two, three, four, five, six, seven, or more. The orientation and number of the dividers 108 may also vary and may be adjustable. One or more dividers 108 may be added or removed, for instance, to accommodate different numbers and sizes of containers 111 placed within the tray 104 for a given freeze-drying process.

The number of containers 111 placed in a single tray 104 may range from one to about ten or more, including two, three, four, five, six, seven, eight, or nine containers 111 or more. In some embodiments, multiple containers 111 may be placed within a single cavity 106, depending on the size of both components. Non-limiting examples of the container 111 may have a length LC of about 6-18 inches, such as about 12 inches, and a width WC of about 3-9 inches, such as about 6 inches. By being configured to hold multiple containers 111 at one time, the tray 104 may be well-suited for efficiently bulk drying a biological material without the need for container-specific mechanisms for preventing contamination and exposure to uncontrolled atmospheric conditions, as well as the frequent freeze-dryer decontaminations common to preexisting systems.

In embodiments featuring flexible containers 111 or bags, each of the containers may include at least one membrane 113 configured to allow passage of air or solvent vapor out of, and resist liquid and contaminant passage into, the flexible container 111. According to such examples, each container 111 may be placed in a cavity 106 of the tray 104 with the membrane 113 facing up, toward the underside of the lid 102. The dimensions of the membrane 113 may vary, depending in part on the size of the containers 111. Non-limiting examples of the membrane 113 can have a length of about 1-3 inches, such as about 2 inches, and a width of about 2-4 inches, such as about 3 inches. The membrane's material can be selected for its combination of high aseptic barrier properties, high resistance to penetration and wetting by liquid water, and low resistance to solvent vapor flow. Examples include aseptic papers, woven or non-woven polymeric fabrics, such as spun-bonded polyolefin, polymer membranes, such as PTFE and ePTFE, glass fiber, nitrocellulose, mixed cellulose esters, polyvinylidene fluoride (PVDF), polyethersulfone, polycarbonate, nylon, polypropylene, and PVC. PTFE may be used for its combination of hydrophobicity and solvent vapor flow for a given nominal pore size.

Due to the presence and unique configuration of the tray assembly 100, the container 111 may advantageously exclude a removable cover or other component configured to protect the membrane 113 during any pre- and post-lyophilization processing. The configuration of the tray assembly 100 may also enable a variety of containers 111 to be used for freeze-drying, examples of which may include or exclude protective membranes or similar mechanisms.

A flexible container 111 may comprise a scalable material made of an inert medical grade plastic material, such as polyvinyl chloride (PVC), polypropylene, or high density polypropylene, which is designed to resist tearing and puncturing that can be encountered in normal handling. The sealable material can be selected to be transparent to allow visual inspection of the biological material within the flexible container 111 and can be available in a variety of sizes, such as about 10 mL up to about 10 L.

The tray assembly 100 may be made from a variety of materials. The lid 102, tray 104, leg members 114, and/or dividers 108, for example, may comprise stainless steel, e.g., 316 stainless steel. Additional metals or alloys may also be used, provided the materials are capable of withstanding the temperatures and pressures associated with freeze-drying. The sealing member 112 may comprise silicone, e.g., silicone 70D, or one or more additional or alternative compressible materials.

FIG. 1B illustrates a plan view of the tray assembly 100 after coupling the lid 102 with the tray 104. As shown, the perimeter of the lid 102 may be rectangular or approximately rectangular, while the perimeter wall 110 of the tray 104 may include rounded corner portions 116 matching the rounded corners of the sealing member 112. The shape of the lid 102 and/or tray 104 may vary. Other embodiments may feature lids and/or trays that are approximately square, oblong, oval, circular, irregular, or other, for example.

The planar dimensions of the lid 102 may be slightly greater than those of the tray 104, such that instead of fitting within the tray 104, the lid 102 may rest on top of the perimeter wall 110 defined by the tray 104. Portions of the lid 102 may extend beyond at least a portion of the perimeter of the tray 104, defining overhang portions when the lid 102 and tray 104 are coupled, which may facilitate manual removal of the lid 102 from the tray 104. The leg members 114 may be positioned near the edge of the lid perimeter, offset from the corners. The example shown includes four leg members 114 positioned near the side portions 110b of the perimeter wall 110, offset from the end portions 110a. Additional embodiments may contain fewer or more legs, such as one, two, three, five, six, seven, eight legs, or more.

FIG. 1C illustrates a side view of the tray assembly 100 in an open configuration in which a gap 118 is present between the lid 102 and the tray 104. The gap 118 allows air and solvent vapor to be released from the container(s) 111 placed in the cavities 106 of the tray 104 during the freeze-drying process. The leg members 114 may remain in an extended position in the open configuration, such that a stabilizing support base 120 of a lower telescoping portion 122 of each leg member 114 is seated against the floor of the tray 104, but the lower telescoping portion 122 is not fully retracted within the upper portion 124.

In the specific embodiment shown in FIG. 1C, the lower telescoping portion 122 comprises an elongate shaft or detent pin member configured to be slidably received within the upper portion 124 defining a complementary tube member. Examples of the detent pin member may include a ball detent pin (e.g., having one, two, three or more ball members) configured to be received within one or more lateral cavities or circumferential slots defined by an inner surface of the upper portion 124. In some examples, a single lateral cavity or circumferential slot may be defined by an inner surface of the upper portion 124, for example near the lower end of the upper portion 124, where reversible engagement of a detent member (e.g., ball) protruding from the lower telescoping portion 122 with the slot may lock the leg member 114 in an extended configuration. In other embodiments, separate circumferential slots may be defined by the upper portion 124, spaced apart along the longitudinal axis of the upper portion 124, such that one or more slots are defined near a first, lower end of the upper portion 124, and one or more slots are defined near a second, upper end of the upper portion 124. Locking engagement of the detent member with the slots defined near the lower end of the upper portion 124 may secure the tray assembly 100 in the open configuration, and locking engagement of the detent member with the slots defined near the upper end of the upper portion 124 may secure the tray assembly 100 in the closed configuration. Unlocking the tray assembly to allow transitioning between the two configurations may be achieved by urging the ball members from their respective receiving slots. In particular, transitioning from the open configuration to the closed configuration may involve applying a downward force sufficient to remove the detent member(s) from their corresponding slot(s), as described below in connection with a movable freeze-dryer shelf. Transitioning from the closed configuration to the open configuration may involve applying a force of equal or greater magnitude in the opposite direction. Additional adjustment mechanisms or components, such as other detent components or springs, may be utilized to reversibly increase and decrease the length of the leg members 114 and lock the leg members 114 in the open and/or closed configuration. In some embodiments, for example, the leg members 114 may be biased toward the open configuration. According to such embodiments, only one end of the upper portion 124 (e.g., the upper end) may define lateral slots configured to receive the detent member(s) of the lower telescoping portion 122. In some examples, the leg members 114 may be temporarily locked in the closed configuration to prevent accidental removal of the lid 102 and increase allowable storage time. Additional locking mechanisms may be provided to secure the lid 102 to the tray 104.

Additional components, members, and/or mechanisms may be utilized in addition or alternatively to the leg members 114 to maintain the gap 118 between the lid 102 and tray 104 until the freeze-drying process is complete, at which point the components, members, and/or mechanisms may be engaged or adjusted to close the lid 102 against the tray 104. Non-limiting examples of such components, members, and/or mechanisms may comprise one or more compressible dried foam components, collapsible members, and/or items that can be crushed or otherwise broken upon urging the lid 102 against the tray 104.

FIG. 1D illustrates an adjustable freeze-dryer shelf 126 positioned above the tray assembly 100. The shelf 126 can be configured to apply pressure against the lid 102 upon being lowered in the direction of the arrows, thereby urging the lid 102 against the tray 104 and closing the gap 118 between the two components until the closed configuration is attained. The shelf 126 may be lowered after freeze-drying is complete, but before the dryer door is opened, so that vapor is allowed to exit the container 111 during the freeze-drying process, but then sealed to prevent contamination and ambient air exposure afterward, preferably before the tray assembly 100 is removed from the freeze-drying chamber. The tray assembly 100 may be maintained in the closed configuration until transported to a controlled environment where the risk of contamination is low, for example in a sterile, low-moisture environment. The tray assembly 100 may then be opened and the container removed for additional processing. Multiple shelves 126 may be included in a freeze-drying chamber, each shelf configured to support at least one tray assembly 100 and at least one shelf configured to be raised and lowered to open and close the tray assemblies, respectively. Shelf-height adjustment may be implemented at the direction of a computer controller.

In an example, the freeze-dried biological material can be a blood plasma unit, which can include about 250-270 mL or other amount of blood plasma from a single donor. The blood plasma unit, for example, can be dried so that its moisture content is below about 5% weight/weight (w/w), which can be stored, transported, and later reconstituted and applied to a subject. The moisture content of the blood plasma unit after drying can vary, ranging from less than about 1% w/w to about 15% w/w, more than 15% w/w, or anywhere therebetween.

Freeze-dried material sealed within the container 111 can be stored for long periods of time. For instance, a container 111 can maintain the freeze-dried material prior to its reconstitution in a moisture-free environment, thereby accommodating long-term storage (e.g., about two to three years at refrigerated temperatures and a plurality of months at room temperature) and retaining its desired qualities for transfusion.

FIG. 1E shows an underside 102a of the lid 102, including the four leg members 114 each having an upper portion 124, lower telescoping portion 122, and support base 120.

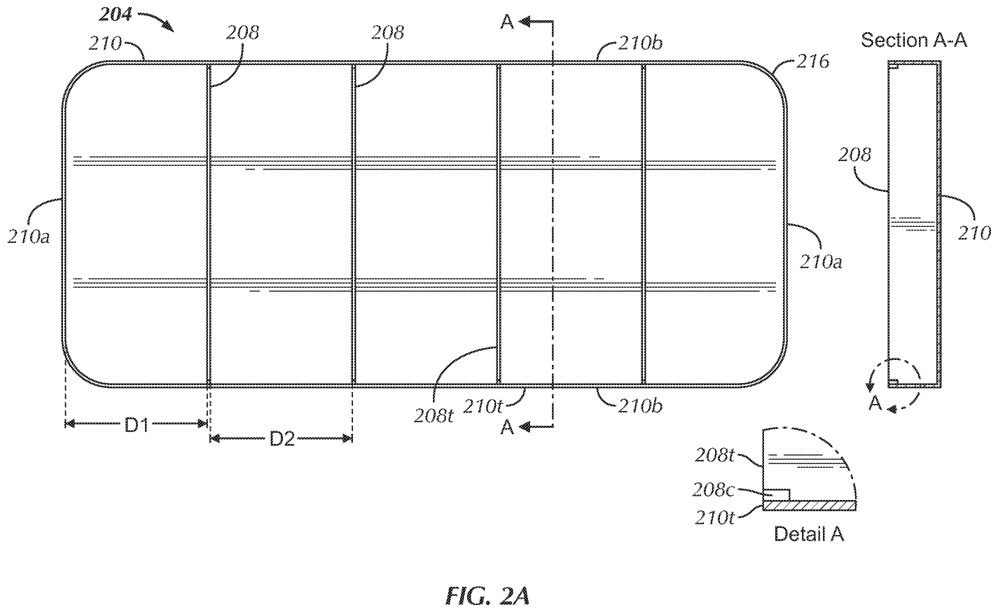

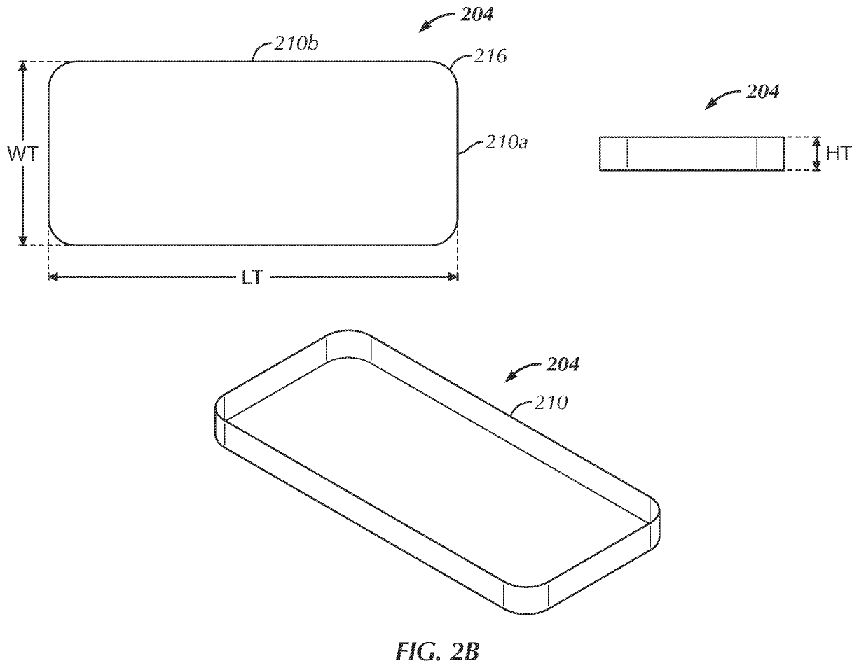

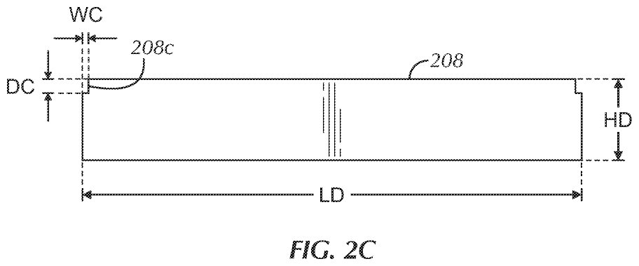

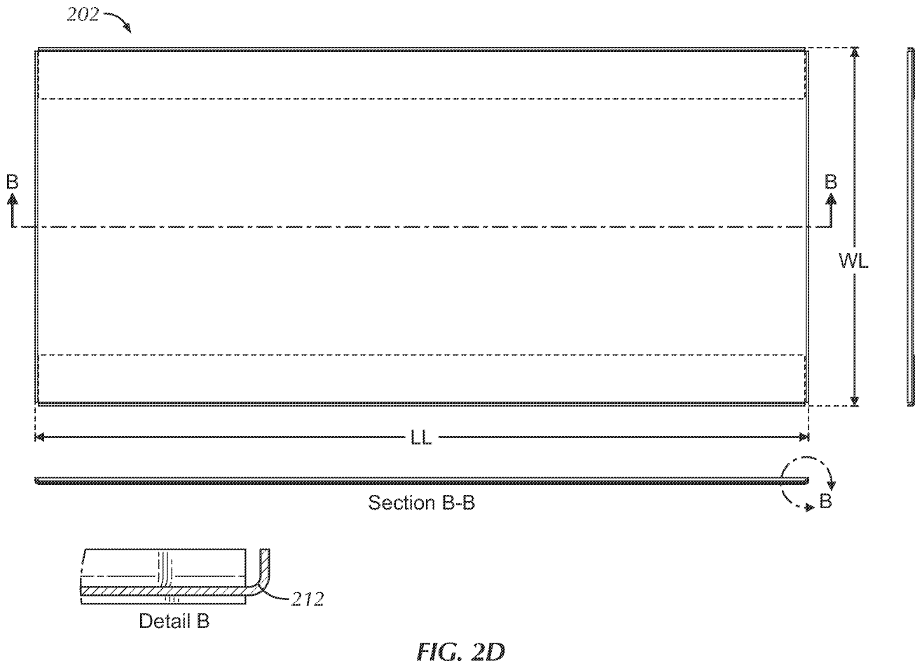

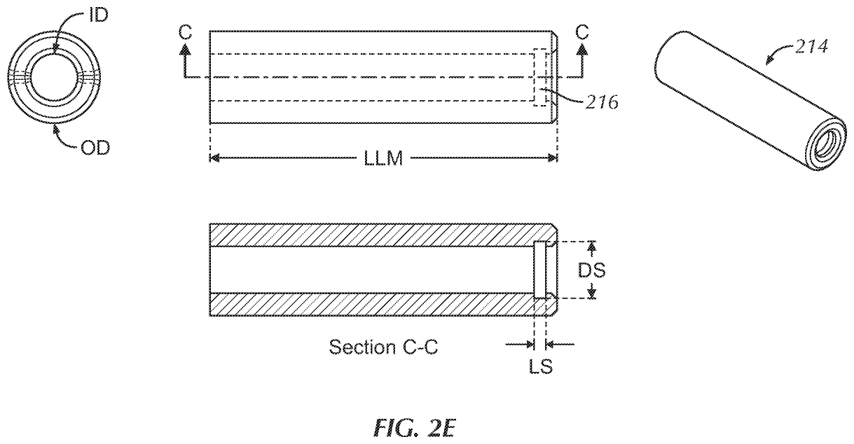

FIGS. 2A-2E illustrate components of a tray assembly, e.g., tray assembly 100, along with non-limiting, example dimensions of each component in accordance with various embodiments disclosed herein.

FIG. 2A is a plan view of a tray 204, showing the dividers 208 spanning between the side portions 210b of the perimeter wall 210. In the example shown, the distance D1 between the left end portion 210a and the closest divider 208 is about 5.8 inches (+/−0.25 inches), as is the distance D2 between adjacent dividers 208. The distance between dividers 208 (and between dividers 208 and adjacent end portions 210a) may vary, ranging in various non-limiting examples from about 3 inches to about 3.5 inches, to about 4.0 inches, to about 4.5 inches, to about 5.0 inches, to about 5.5 inches, to about 6.0 inches, to about 6.5 inches, to about 7.0 inches, to about 7.5 inches, to about 8.0 inches, to about 8.5 inches, to about 9.0 inches, to about 9.5 inches, to about 10 inches, or more. The position of one or more dividers 208 may be adjusted in some examples to accommodate a variety of differently sized and shaped containers.

Cross-section A-A and Detail A show that an approximately 90° angle may be defined by the intersection between a top portion 208t of a divider 208 and a side portion 210b of the perimeter wall 210 (upper portion of side portion 210b designated as 210t). Other suitable configurations also may be used. Detail A shows a cutout portion 208c of the divider 208 defined near the upper portion 210t of the perimeter wall 210. The cutout portion 208c may be configured to receive a sealing member, such as sealing member 112.

FIG. 2B illustrates the tray 204 without any dividers. The width WT of the tray 204 may be about 13.25 inches (+/−0.1 inches) in specific embodiments, ranging in other non-limiting embodiments from about 8 inches to about 8.5 inches, to about 9.0 inches, to about 9.5 inches, to about 10.0 inches, to about 10.5 inches, to about 11.0 inches, to about 11.5 inches, to about 12.0 inches, to about 12.5 inches, to about 13.0 inches, to about 13.5 inches, to about 14.0 inches, to about 14.5 inches, to about 15.0 inches, to about 15.5 inches, to about 16.0 inches, to about 16.5 inches, to about 17.0 inches, to about 17.5 inches, to about 18.0 inches, to about 18.5 inches, to about 19.0 inches, to about 19.5 inches, to about 20.0 inches, or more, or any width therebetween.

The length LT of the tray 204 may be about 29 inches in specific embodiments, ranging in other non-limiting embodiments from about 20 inches to about 20.5 inches, to about 21.0 inches, to about 21.5 inches, to about 22.0 inches, to about 22.5 inches, to about 23.0 inches, to about 23.5 inches, to about 24.0 inches, to about 24.5 inches, to about 25.0 inches, to about 25.5 inches, to about 26.0 inches, to about 26.5 inches, to about 27.0 inches, to about 27.5 inches, to about 28.0 inches, to about 28.5 inches, to about 29.0 inches, to about 29.5 inches, to about 30.0 inches, to about 30.5 inches, to about 31.0 inches, to about 31.5 inches, to about 32.0 inches, to about 32.5 inches, to about 33.0 inches, to about 33.5 inches, to about 34.0 inches, to about 34.5 inches, to about 35.0 inches, to about 35.5 inches, to about 36.0 inches, to about 36.5 inches, to about 37.0 inches, to about 37.5 inches, to about 38.0 inches, to about 38.5 inches, to about 39.0 inches, to about 39.5 inches, to about 40.0 inches or more, or any length therebetween.

The height HT of the tray 204 may be about 2.125 inches (+/−0.05 inches) in specific embodiments, ranging in other non-limiting embodiments from about 1.0 inches to about 1.5 inches, to about 2.0 inches, to about 2.5 inches, to about 3.0 inches, to about 3.5 inches, to about 4.0 inches, to about 4.5 inches, to about 5.0 inches, or more, or any height therebetween.

FIG. 2C illustrates a front view of a divider 208. The length LD of the divider 208 may be slightly less than the width of the tray 204, for example about 0.1 inches less in some examples. The height HD of the divider 208 may be slightly less than the height H of the tray 204, for example about 0.1 inches less. The depth DC of the cutout portion may range in non-limiting examples from about 0.25 inches to about 0.3 inches, and the width WC of the cutout portion may range in non-limiting examples from about 0.1 inches to about 0.15 inches.

FIG. 2D illustrates various views of the lid 202. The length LL of the lid 202 may be about 30.0 inches in specific embodiments, ranging in other non-limiting embodiments from about 20 inches to about 20.5 inches, to about 21.0 inches, to about 21.5 inches, to about 22.0 inches, to about 22.5 inches, to about 23.0 inches, to about 23.5 inches, to about 24.0 inches, to about 24.5 inches, to about 25.0 inches, to about 25.5 inches, to about 26.0 inches, to about 26.5 inches, to about 27.0 inches, to about 27.5 inches, to about 28.0 inches, to about 28.5 inches, to about 29.0 inches, to about 29.5 inches, to about 30.0 inches, to about 30.5 inches, to about 31.0 inches, to about 31.5 inches, to about 32.0 inches, to about 32.5 inches, to about 33.0 inches, to about 33.5 inches, to about 34.0 inches, to about 34.5 inches, to about 35.0 inches, to about 35.5 inches, to about 36.0 inches, to about 36.5 inches, to about 37.0 inches, to about 37.5 inches, to about 38.0 inches, to about 38.5 inches, to about 39.0 inches, to about 39.5 inches, to about 40.0 inches, to about 40.5 inches, to about 41.0 inches or more, or any length therebetween.

The width WL of the lid 202 may be about 13.8 inches in specific embodiments, ranging in other non-limiting embodiments from about 8 inches to about 8.5 inches, to about 9.0 inches, to about 9.5 inches, to about 10.0 inches, to about 10.5 inches, to about 11.0 inches, to about 11.5 inches, to about 12.0 inches, to about 12.5 inches, to about 13.0 inches, to about 13.5 inches, to about 14.0 inches, to about 14.5 inches, to about 15.0 inches, to about 15.5 inches, to about 16.0 inches, to about 16.5 inches, to about 17.0 inches, to about 17.5 inches, to about 18.0 inches, to about 18.5 inches, to about 19.0 inches, to about 19.5 inches, to about 20.0 inches, to about 20.5 inches, to about 21 inches, to about 21.5 inches, to about 22.0 inches or more, or any width therebetween.

As shown in Detail B and cross-section B-B, the perimeter of the tray 202 may include an overhang portion 212, which may facilitate manual gripping of the lid 202 and coupling between the lid 202 and a sealing member, e.g., sealing member 112.

FIG. 2E illustrates a compressible member component in the form of a leg member component 214, such as the upper portion 124 of leg member 114. As shown, the leg member component 214 includes a circumferential inner slot 216 sized and configured to receive a detent member (e.g., detent ball) or similar component protruding from a lateral side of a detent pin member, such as lower portion 122 of leg member 114. As represented by cross-section C-C, the diameter DS of the inner slot 216 may be about 0.3 inches in specific embodiments, ranging from about 0.1 inches to about 0.5 inches in other non-limiting examples. The LS of the inner slot 216 may be about 0.065 inches in specific embodiments, ranging from about 0.05 to about 0.1 inches in other non-limiting examples.

The length LLM of the leg member component 214 may be about 1.9 inches in specific embodiments, ranging from about 1.0 inches to about 4.0 inches in other non-limiting examples. The outer diameter OD of the leg member component 214 may be about 0.5 inches in specific embodiments, ranging from about 0.25 inches to about 1.0 inches in other non-limiting examples. The inner diameter ID of the leg member component 214 may be about 0.25 inches in specific embodiments, ranging from about 0.15 inches to about 0.35 inches in other non-limiting embodiments.

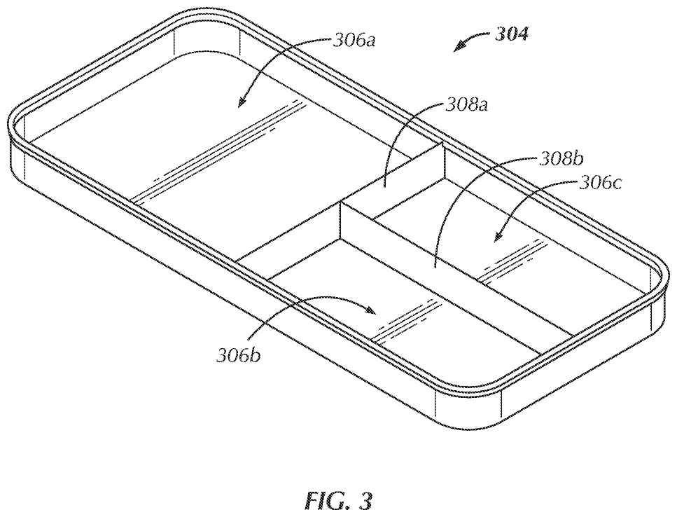

In some embodiments, the position of one or more dividers may be adjusted so that the dividers are not parallel to each other, but rather angled or perpendicular. For instance, FIG. 3 illustrates a tray 304 that includes two dividers 308a and 308b arranged perpendicular to each other. In this configuration, the tray 304 thus includes three cavities 306a, 306b, 306c, each configured to receive at least one container filled with biological material.

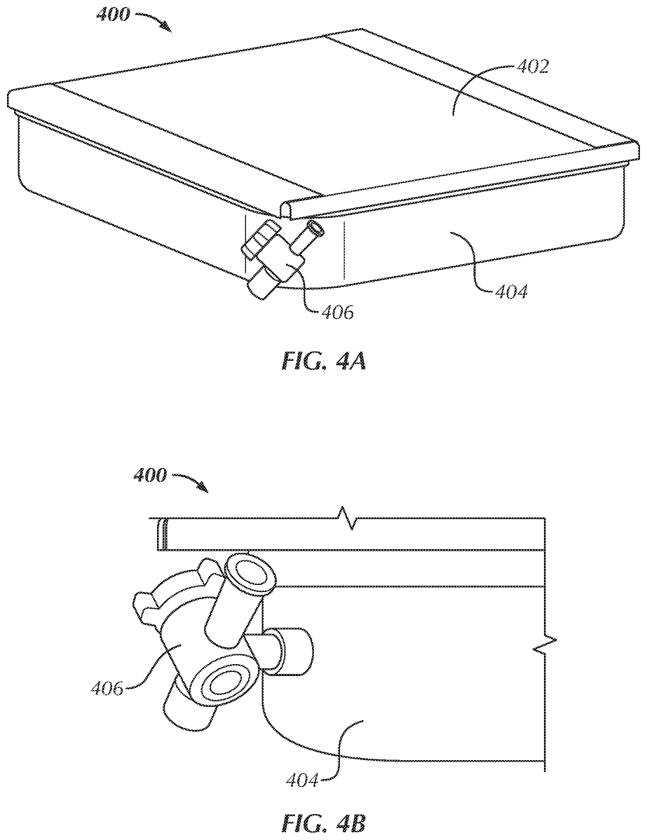

FIG. 4A illustrates tray assembly 400 featuring a lid 402, a tray 404, and a vent port 406 comprising a luer lock. The vent port 406 may be optional and may be used to inject a gas (e.g., nitrogen or carbon dioxide), or allow the entrance of air to break a vacuum seal between the lid and the tray. FIG. 4B shows a close-up view of the vent port 406 protruding from an exterior surface of the tray 404.

The disclosed tray assemblies and associated methods of use may be critical to the provision of first aid to subjects who have suffered a serious injury, such as a wound sustained during an accident or military operation. While it is necessary to treat a wound and stop the bleeding of a subject, it is also important to ensure that the subject's body is capable of properly functioning. Thus, it is necessary to take steps to ensure that the subject's body is properly hydrated after losing fluids due to the wound.

Using existing technology, fluids within a subject are typically replenished by intravenously delivering saline. While effective, the delivery of blood plasma to a subject is even more effective in replenishing fluid to the subject. Processing, storage, and delivery of the blood plasma may be critical to preventing its contamination and preserving its desired physical properties. An effective way of delivering blood plasma is to store it in a freeze-dried form and reconstitute the blood plasma at the time it is administered to the subject.

An advantage of a freeze-dried material is the possible storage for a comparably longer period of time at temperatures of about 0° C. (Celsius) up to room temperature and beyond, combined with a reduced weight due to reduced water content. Although a freeze-dried material requires reconstitution, the advantages are significant in certain situations, especially in emergency medicine under difficult treatment conditions (e.g., in combat treating wounded warriors or in ambulances and helicopters treating civilian trauma) when the thawing of frozen biological material to be applied is time-consuming (e.g., around 15 minutes or more) and inconvenient.

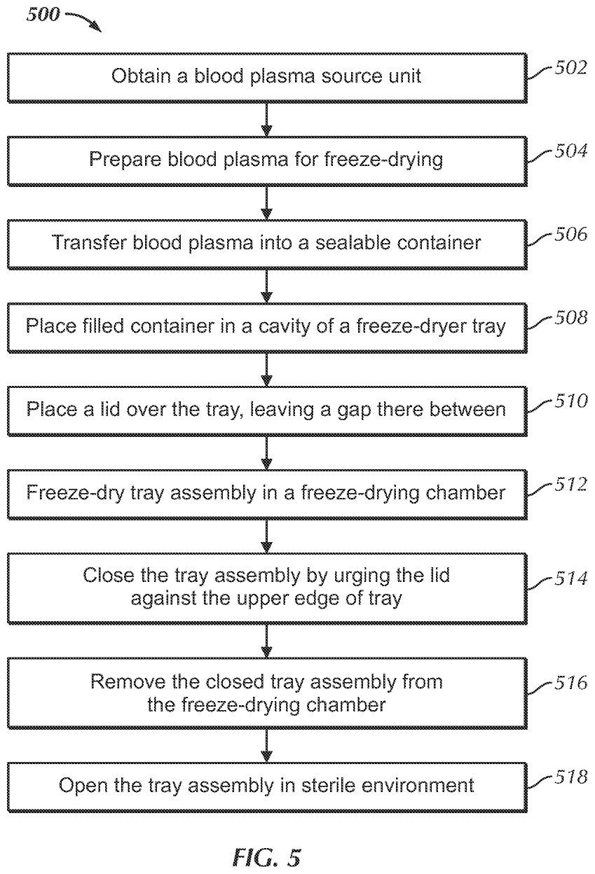

FIG. 5 illustrates a method 500 of filling a container with a biological material, such as blood plasma, inserting the filled container within a tray of a tray assembly, freeze-drying the biological material in the tray assembly, and removing the blood plasma from the freeze-drying chamber without risk of contamination and ambient air exposure.

In operation 502, a blood plasma source unit can be obtained. Blood plasma can be obtained from a single donor or a pooling of donors by collecting a unit of whole blood from the donor(s) in a closed system collection bag, followed by centrifugal separation of the blood plasma and its collection in an integrally connected transfer bag. The blood plasma can be obtained in individual units of about 270 mL, for example, shipped frozen and stored in a 20° C. freezer. Identification information, maintained by barcoding or other tagging means, can be supplied with each individual donor blood plasma unit for traceability purposes.

In operation 504, the blood plasma source unit can be prepared for freeze-drying. The blood plasma unit can be removed from the freezer and any associated packaging can be discarded. The blood plasma unit can be transferred into a plasma thawing unit and allowed to thaw. The thawed blood plasma unit can be barcode scanned, for example, and an identification tag can be made. The identification tag can include unit-specific information to maintain traceability of the blood plasma.

In operation 506, the blood plasma can be transferred into a container disclosed herein, which may be a water-impermeable, vapor-permeable, aseptic, scalable flexible container in some embodiments. The container and the blood plasma source unit can be coupled together using a material entry port in the form of aseptic tubing. The blood plasma can be transferred through the aseptic tubing using positive pressure. The total mass of the transferred blood plasma can be about 270 g. Once the blood plasma has been transferred, a portion of the aseptic tubing can be thermally or otherwise sealed to protect the unit from contamination and ambient air exposure.

In operation 508, the filled container can be placed in a cavity of a horizontally-oriented freeze-dryer tray. In operation 510, a lid may be placed over the tray without sealing the lid against the tray, such that a horizontal gap exists between the underside of the lid and the upper edge of the tray. The open tray assembly can then be placed on a shelf within a freeze-drying chamber and freeze-dried in operation 512. Freeze-drying the container with the tray assembly in the open configuration allows for controlled and consistent conduction during the freeze-drying process, as air or solvent vapor can escape the container, e.g., through a membrane, as well as the tray assembly, through the gap between the lid and the tray.

Freeze-drying may involve cooling the shelf using a heating and cooling unit to preliminarily freeze the material to be freeze-dried. Alternatively, the filled container to be freeze-dried can be pre-frozen using a separate unit (e.g., a −60° C. freezer) and arranged on the shelf. Solvent vapor released from the material in the container by sublimation can be captured by a cold trap or other type of capturing unit. In the case of using a cold trap (condenser unit), the cold trap can be cooled to a temperature below the temperature of the material, and preferably to a temperature that demonstrates a solvent vapor pressure sufficiently lower than the solvent vapor pressure of water at the temperature of the contents (for example, −50 to −60° C.).

In an example, the freeze-drying cycle can include cooling the shelf to less than about −40° C., loading the filled container and its tray onto the shelf, initiating a six or seven day freeze-drying cycle including a four or five day primary drying cycle and a two day secondary drying cycle, ending the secondary drying cycle and break vacuuming using extra dry, high purity carbon dioxide.

In operation 514, the tray assembly can be closed by lowering a shelf positioned directly above the tray assembly onto the lid and urging the lid downward (by compressing the leg members of the assembly) until it is sealed against the upper edge of the tray. In this closed configuration, the tray assembly can be removed from the freeze-drying chamber in operation 516 and moved to a sterilized environment, such as a desiccated storage chamber. The tray assembly can then be opened in operation 518 and the container removed therefrom. The tray assembly can be reused after sterilization.

The sequence of steps depicted in FIG. 5 can be varied as appropriate.

### CLOSING NOTES

Existing assemblies, systems, and methods for freeze-drying, repackaging and using freeze-dried contents suffer from concerns of contamination, expense and lack of convenience. Advantageously, the present subject matter provides an economical and efficient assembly, system, and method for protecting material from contamination and unwanted alteration through the steps of filling, freeze-drying, packaging, storing and use. The assembly, system, and method can be designed for blood products, such as blood plasma, and can be adoptable to other materials that would benefit from the design and features of the invention.

The above Detailed Description includes references to the accompanying drawings, which form a part of the Detailed Description. The Detailed Description should be read with reference to the drawings. The drawings show, by way of illustration, specific embodiments in which the present assemblies, systems, and associated methods can be practiced. These embodiments are also referred to herein as “examples.”

The Detailed Description is intended to be illustrative and not restrictive. For example, the above-described examples (or one or more features or components thereof) can be used in combination with each other. Other embodiments can be used, such as by one of ordinary skill in the art upon reviewing the above Detailed Description. Also, various features or components have been or can be grouped together to streamline the disclosure. This should not be interpreted as intending that an unclaimed disclosed feature is essential to any claim. Rather, inventive subject matter can lie in less than all features of a particular disclosed embodiment. Thus, the following claim examples are hereby incorporated into the Detailed Description, with each example standing on its own as a separate embodiment:

Certain terms are used throughout this patent document to refer to particular features or components. As one skilled in the art appreciates, different people may refer to the same feature or component by different names. This patent document does not intend to distinguish between components or features that differ in name but not in function.

For the following defined terms, certain definitions shall be applied unless a different definition is given elsewhere in this patent document. The terms “a,” “an,” and “the” are used to include one or more than one, independent of any other instances or usages of “at least one” or “one or more.” The term “or” is used to refer to a nonexclusive or, such that “A or B” includes “A but not B,” “B but not A,” and “A and B.” All numeric values are assumed to be modified by the term “about,” whether or not explicitly indicated. The term “about” generally refers to a range of numbers that one of skill in the art would consider equivalent to the recited value (e.g., having the same function or result). In many instances, the term “about” can include numbers that are rounded to the nearest significant figure. The recitation of numerical ranges by endpoints includes all numbers and sub-ranges within and bounding that range (e.g., 1 to 4 includes 1, 1.5, 1.75, 2, 2.3, 2.6, 2.9, etc. and 1 to 1.5, 1 to 2, 1 to 3, 2 to 3.5, 2 to 4, 3 to 4, etc.). The terms “patient” and “subject” are intended to include mammals, such as for human or veterinary applications.

The scope of the invention should be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended; that is, an assembly, system, or method that includes features or components in addition to those listed after such a term in a claim are still deemed to fall within the scope of that claim. Moreover, in the following claims, the terms “first,” “second” and “third,” etc. are used merely as labels, and are not intended to impose numerical requirements on their objects.

The Abstract is provided to allow the reader to quickly ascertain the nature of the technical disclosure. It is submitted with the understanding that it will not be used to interpret or limit the scope or meaning of the claims.

What is claimed is:

1. A freeze-drying tray assembly, comprising:
a tray configured to receive one or more containers each containing a liquid; and
a lid complementary to the tray and including one or more compressible members configured to transition from an extended configuration to a compressed configuration in response to a downward force applied against the lid when the lid is positioned above the tray,
wherein a gap exists between an upper edge of the tray and an underside of the lid when the one or more compressible members are in the extended configuration, and
wherein the lid is sealed against the upper edge of the tray when the one or more compressible members are in the compressed configuration.

2. The tray assembly of claim 1, further comprising a gasket attached to the upper edge of the tray.

3. The tray assembly of claim 1, wherein the tray includes one or more dividers configured to define two or more cavities within the tray, each of the cavities configured to receive at least one of the containers.

4. The tray assembly of claim 3, wherein the dividers are movable within the tray.

5. The tray assembly of claim 1, wherein each of the compressible members comprises a compressible leg member having a first portion and a second portion, the first portion movable relative to the second portion.

6. The tray assembly of claim 5, wherein the first portion comprises a telescoping detent pin member.

7. The tray assembly of claim 6, wherein the second portion comprises a tube member configured to receive the telescoping detent pin member.

8. The tray assembly of claim 7, wherein the tube member is attached to the underside of the lid and the telescoping detent pin member is configured to extend to an interior floor surface of the tray.

9. The tray assembly of claim 8, wherein a support base of the telescoping detent pin member is configured to contact the interior floor surface of the tray.

10. The tray assembly of claim 1, wherein the tray and the lid comprise stainless steel.

11. The tray assembly of claim 1, further comprising a vent port attached to the tray.

12. The tray assembly of claim 1, wherein the tray has a length of about 20 inches to about 40 inches.

13. The tray assembly of claim 1, wherein the tray has a width of about 8 inches to about 20 inches.

14. The tray assembly of claim 1, wherein the tray has a height of about 1 inch to about 5 inches.

15. A system for freeze-drying biological material, comprising:
at least one gas-impermeable container configured to receive a biological material; and
a tray assembly configured to contain the at least one gas-impermeable container, the tray assembly comprising:
a tray configured to receive the at least one gas-impermeable container; and
a lid complementary to the tray and including one or more compressible members configured to transition from an extended configuration to a compressed configuration in response to a downward force applied against the lid when the lid is positioned above the tray,
wherein a gap exists between an upper edge of the tray and an underside of the lid when the one or more compressible members are in the extended configuration, and
wherein the lid is sealed against the upper edge of the tray when the one or more compressible members are in the compressed configuration.

16. The system of claim 15, further comprising a movable freeze-dryer shelf.

17. The system of claim 16, wherein the movable freeze-dryer shelf is configured to apply the downward force against the lid sufficient to seal the lid against the upper edge of the tray.

18. The system of claim 15, wherein the tray assembly further comprises a vent port.

19. The system of claim 15, wherein the biological material comprises blood plasma.

20. The system of claim 15, wherein each of the one or more compressible members comprises a compressible leg member.
